(19) United States
(12) Patent Application Publication
(10) Pub. No.: US 2022/0018600 A1
(43) Pub. Date: Jan. 20, 2022

(54) STRUCTURAL MATRIX FOR STAVE

(71) Applicant: Berry Metal Company, Harmony, PA (US)

(72) Inventor: Kenneth W. Geibel, Sarver, PA (US)

(21) Appl. No.: 17/378,384

(22) Filed: Jul. 16, 2021

Related U.S. Application Data
(60) Provisional application No. 63/053,545, filed on Jul. 17, 2020.

(51) Int. Cl. F27D 1/12

(52) U.S. Cl. CPC F27D 1/12

(57) ABSTRACT

A stave for a metallurgical furnace with a structural matrix fastened to a stave body. The structural matrix includes a plurality of cells open on one end in order to receive refractory material or furnace materials (feed stock, accretions, etc.) such that the received materials are retained by the structural matrix and form an abrasion barrier to protect the stave from future contact by furnace materials.

### BACKGROUND OF THE DISCLOSURE

### 1. Field of the Disclosure

The invention relates to staves for use in a metallurgical furnace. More specifically, the invention relates to structures provided in connection with refractory surfaces of cooling staves used in metallurgical furnaces.

### 2. Description of the Related Art

Historically, stave durability inside a blast furnace has traditionally depended on the surface of the stave remaining protected during the campaign life of the stave. Traditional methods have employed multiple refractory bricks mechanically fitted to the stave, i.e. dovetail, locking brick. In some instances, a stave may have a ribbed/channeled surface that has been utilized to create an alternating refractory pattern. The refractory pattern on the surface of the stave is intended to capture accretions on the furnace wall. The ribbed/channeled/alternating configuration also captures and holds a portion of the furnace feed material, i.e. iron ore, coke, depending on the cohesion zone in the furnace.

The traditional problems with these stave styles have included: the refractory brick eroding too quickly, shearing off of the refractory brick at the edge of the stave face, or spalling of the refractory (overheating and disintegrating). The typical mechanical reasons for these failures have been primarily attributed to the deflection (bending) of the stave during its thermal cycle.

### BRIEF SUMMARY OF THE DISCLOSURE

The present invention resolves an unmet need in the prior art for a resolution of the foregoing problems.

In one embodiment, the present disclosure includes a stave for use in a metallurgical furnace that includes a stave body with a hot face on one side of the stave body; and a structured matrix fastened to the stave body and extending from the hot face; wherein the structured matrix includes a plurality of cells formed by a plurality of walls substantially perpendicular to the hot face and open on one end facing away from the hot face. The structural matrix may be configured to support the flexing of the stave during thermal cycling. The structural matrix may be flat or curved. The stave body may be a cast stave body. The stave body may be made of copper. Each of the plurality of cells may be hexagonal, triangular, circular, or polygonal in shape. Each of the plurality of cells may configured to receive a refractory material, a furnace accretion, or furnace feed stock. The plurality of walls of each cell may be made of at least one of: stainless-steel and high nickel alloys. The plurality of walls may be made of a material more resistant to mechanical wear than the stave body. The fastening of the structural matrix to the stave body may include the structural matrix being partially embedded in the stave body. The fastening of the structural matrix to the stave body may include welding or brazing. In some instances, at least some of the plurality of walls are embedded in the stave body. The open ends of the plurality of cells may be configured to collect and hold furnace wall accretions.

Another embodiment according to the present disclosure includes a method of using a stave in a metallurgical furnace, including the step of: protecting a stave body using at least one of furnace feed stock, furnace accretion, and refractory materials received into open ends of a plurality of cells making up a structural matrix formed by a plurality of walls fastened to a hot face of the stave body. The method may also include a step of: receiving the at least one of furnace feed stock, furnace accretion and refractory materials into the open ends of the plurality of cells.

Another embodiment according to the present disclosure includes a stave for a metallurgical furnace that includes a cast or fabricated stave body with a hot face on one side of the stave body; and a structured matrix embedded in the stave body and extending from the hot face; wherein the structured matrix is made of stainless-steel and high nickel alloys and includes a plurality of cells formed by a plurality of walls substantially perpendicular to the hot face and open on one end facing away from the hot face.

### BRIEF DESCRIPTION OF THE FIGURES

FIG. 1 shows a perspective view of one embodiment according to the present disclosure

FIG. 2A shows a cross-sectional view of a preferred embodiment of the present disclosure, provided a Section A-A of FIG. 3.

FIG. 2B shows an alternative view of a preferred embodiment of the present disclosure.

FIG. 3 shows a front view of a preferred embodiment of the present disclosure.

FIG. 4 shows a flow chart of a method of using an embodiment according to the present disclosure.

### DETAILED DESCRIPTION OF THE DISCLOSURE

While the present disclosure may be susceptible to embodiments in different forms, there is described herein in detail, a specific embodiment with the understanding that the present disclosure is to be considered an exemplification of the principles of the disclosure and is not intended to limit the disclosure to that described herein.

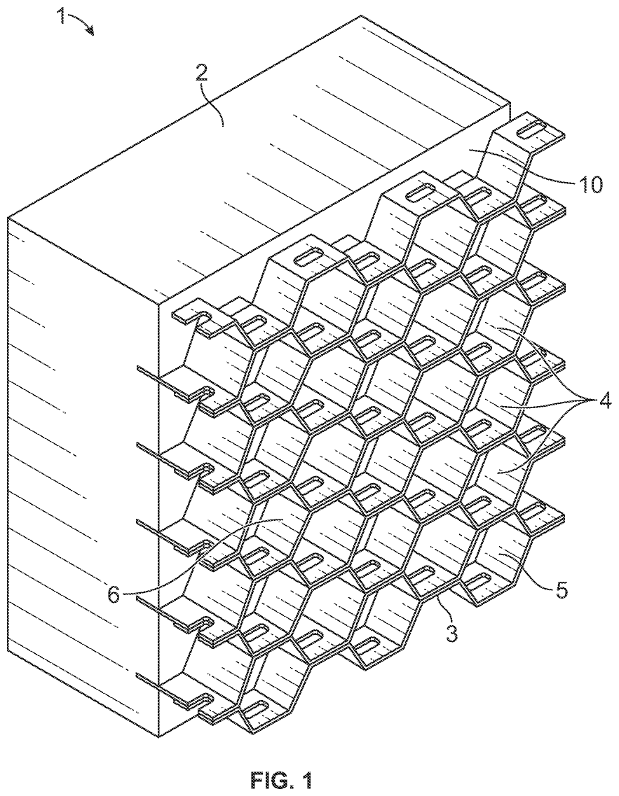

FIGS. 1-3 show a stave according to one embodiment of the present disclosure. FIG. 1 shows a 3-dimensional diagram of a stave 1. The stave 1 may be fabricated or cast. The stave 1 may include a stave body 2 and a structural matrix 3. The structural matrix 3 may be secured to a hot face 10 of the stave body 2 to create a multiple cell system 4 made up of a plurality of cells 6 formed by cell walls 5. The multiple cell system 4 is configured to receive and hold an installed refractory material whereby risks to the refractory material are reduced in terms of: (i) erosion, (ii) shear, and (iii) spall. The cell walls 5 may be made of a material that is more resistant to mechanical wear than the stave body 2. The cell walls 5 may be in a plane substantially perpendicular to the hot face 10. The stave body may be made of copper or cast iron. In some embodiments, the cell walls 5 may be made of a form of stainless-steel. In some embodiments, the cell walls 5 may be made of stainless-steel and high nickel alloys. In some embodiments, the structural matrix 3 is made up of the same materials as the cell walls 5. The cell walls 5 are configured to resist shearing forces and to protect the refractory material, such as a refractory brick, that is disposed within the cells 6 of the multiple cell system 4. The cell walls 5 are configured to flex with the thermal cycle of the stave 1. As such, the structural matrix 3 can flex during the thermal growth cycle of the stave 1. In some embodiments, the cells 6 may be dimensioned to receive and hold smaller volumes than present in traditional refractory bricks, which reduces the impact of losing one of the refractory bricks if it becomes dislodged during operations. The cell walls 5 may be configured to have sufficient height 7 from the stave body 2 in order to protect the refractory bricks from objects falling from above. The raised cell walls 5 also serve as a substrate for furnace accretions and furnace feed material, whereby accumulations are caught by the structural matrix 3 and form an abrasion resistant barrier to further impacts due to furnace feed materials and other objects within the furnace. Thus, the amount of spalling of the refractory and the loss of furnace wall accretions is reduced.

The structural matrix 3 is shown as hexagonal; however, this is illustrative and exemplary only, as the cells 6 of the structural matrix 3 may be of any shape, including, but not limited to, rectangular, square, triangular, hexagonal, octagonal, circular. While the cells 6 are shown of uniform size and shape, this is also illustrative and exemplary, as the cells 6 may include combinations of sized and shapes interconnected to form the structural matrix 3. In some embodiments, the geometry of the cells 6 may be selected to accommodate the furnace lining (i.e. poured or cast refractories, sprayed in refractory linings, rammable refractories or no refractory, utilizing the furnace accretion alone to coat stave body 2).

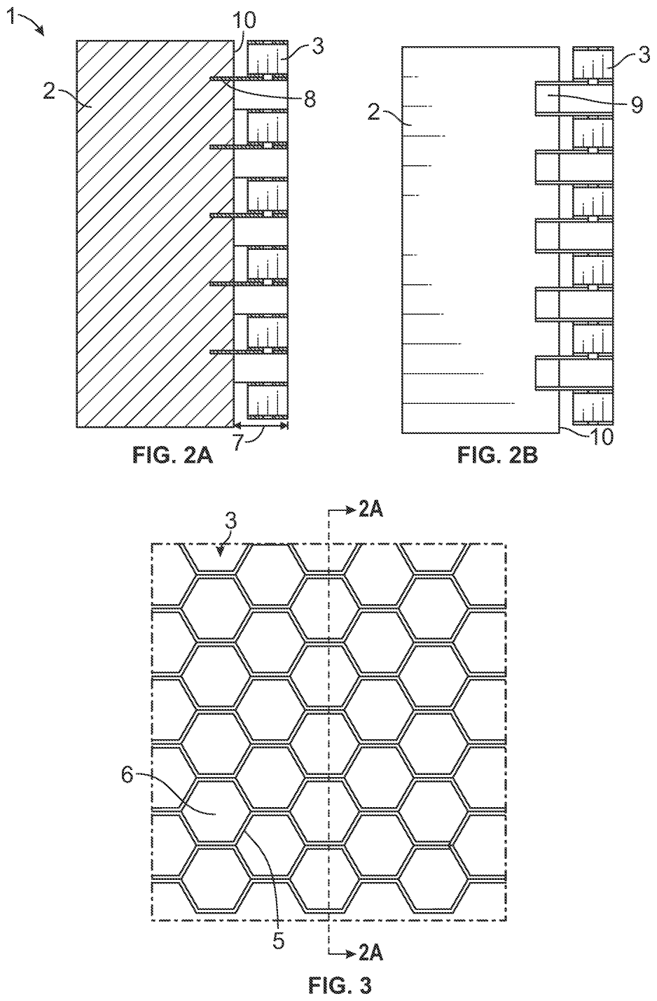

FIG. 2A shows a side view diagram of the stave 1 with the structural matrix 3. Here the height 7 of the cell walls 5 extending beyond the stave body 2 may be clearly seen. A portion 8 of the structural matrix 3 may be bonded (cast-in), embedded, or otherwise fastened to the hot face 10 of the stave body 2 to secure the structural matrix 3 to the cast or fabricated stave 1.

FIG. 2B shows an alternative side view diagram of the stave 1, wherein portions 9 each of the walls 5 associated with one or more entire cells 6 are embedded in the stave 2. The walls 5 may extend out to the same distance 7 from the hot face 10; however, in some embodiments, some walls may extend the full distance 7, some may include an embedded portion 8, and some may not extend entirely to the hot face 10, as would be understood by a person of skill in the art. Thus, every cell 6 does not need to have all of its respective cell walls 5 in direct contact with the hot face 10. In some embodiments, not shown, all of the cell walls 5 in the structural matrix 3 may directly contact the hot face 10.

FIG. 3 shows a front view diagram of the stave 1, whereby the structural matrix 3 covers the stave body 2.

In some embodiments, the structural matrix 3 may be cast into stave body 2. The structural matrix 3 may be welded or brazed to an existing stave 1 or the rolled, forged, or cast stave body 2. The structural matrix 3 may be welded or brazed to a drilled and plugged stave 1, the stave 1 including a rolled, forged, or cast stave body 2.

The addition of the structural matrix 3 with a plurality of cells 6 to the hot face 10 of the stave 1 improves protection of the hot face 10 and provides a holding apparatus for: (i) abrasion resistant refractory; (ii) furnace accretions; and (iii) blast furnace feed stock.

In operation, the structural matrix 3 may collect and hold furnace feed materials, allowing and promoting the material to abrade against itself. The held feed materials further protect the base material of the cooling stave 1. The structural matrix 3 also acts as a substrate for field applied protective coatings.

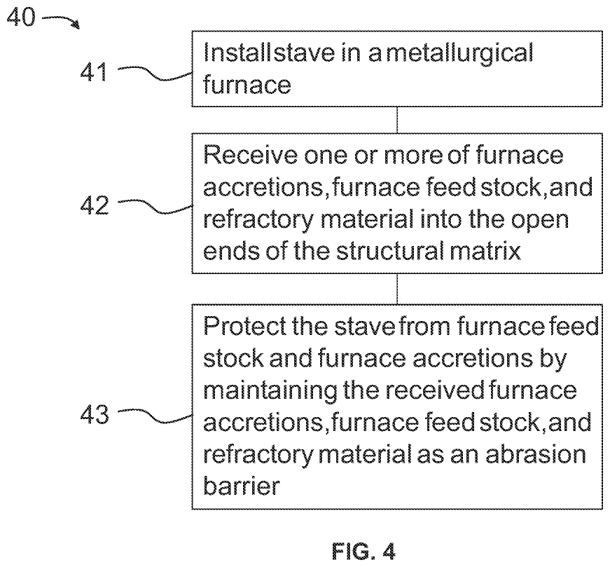

FIG. 4 shows a flow chart of a method 40 of using the stave 1. In step 41, the stave 1 is installed in a metallurgical furnace. In step 42, furnace feed stock, furnace accretion, and/or refractory materials are received by the cells 6 of the structural matrix 3 to form an abrasion barrier. In step 43, the abrasion barrier of received materials protect the stave 1 from abrasion cause by other furnace accretion and or furnace feed stock that may contact the stave.

When installed inside a blast furnace, or similar metallurgical furnace, the structural matrix 3 may be formed to support the contour of the wall shape (flat or curved) of the furnace to which the stave 1 is installed. The structural matrix 3 supports the flexing of the stave 1 during thermal cycling.

While specific embodiments of the disclosure have been shown and described, it is envisioned that those skilled in the art may devise various modifications without departing from the spirit and scope of the present disclosure.

1. A stave for use in a metallurgical furnace comprising:
a stave body with a hot face on one side of the stave body; and
a structured matrix fastened to the stave body and extending from the hot face;
wherein the structured matrix comprises:
a plurality of cells formed by a plurality of walls substantially perpendicular to the hot face and open on one end facing away from the hot face.

2. The stave of claim 1, wherein the structural matrix is configured to support the flexing of the stave during thermal cycling.

3. The stave of claim 1, wherein the structural matrix is one of: flat and curved.

4. The stave of claim 1, wherein the stave body is a cast stave body.

5. The stave of claim 1, wherein the stave body is made of copper.

6. The stave of claim 1, wherein each of the plurality of cells is hexagonal in shape.

7. The stave of claim 1, wherein each of the plurality of cells is configured to receive a refractory material.

8. The stave of claim 1, wherein the plurality of walls of each cell are made of at least one of: stainless-steel and high nickel alloys.

9. The stave of claim 1, wherein the plurality of walls is made of a material more resistant to mechanical wear than the stave body.

10. The stave of claim 1, wherein the fastening of the structural matrix to the stave body includes the structural matrix being partially embedded in the stave body.

11. The stave of claim 1, wherein the fastening of the structural matrix to the stave body includes at least one of welding and brazing.

12. The stave of claim 1, wherein at least some of the plurality of walls are embedded in the stave body.

13. The stave of claim 1, wherein the open ends of the plurality of cells are configured to collect and hold furnace wall accretions.

14. A method of using a stave in metallurgical furnace, the steps comprising:
protecting a stave body using at least one of furnace feed stock, furnace accretion, and refractory materials received into open ends of a plurality of cells making up a structural matrix formed by a plurality of walls fastened to a hot face of the stave body.

15. The method of claim 14, further comprising:
receiving the at least one of furnace feed stock, furnace accretion and refractory materials into the open ends of the plurality of cells.

16. A stave for a metallurgical furnace comprising:
a cast or fabricated stave body with a hot face on one side of the stave body; and
a structured matrix embedded in the stave body and extending from the hot face;
wherein the structured matrix is made of stainless-steel and high nickel alloys and comprises a plurality of cells formed by a plurality of walls substantially perpendicular to the hot face and open on one end facing away from the hot face.
